(19) United States
(12) Patent Application Publication
(10) Pub. No.: US 2025/0203741 A1
(43) Pub. Date: Jun. 19, 2025

(54) Smart Led Control

(71) Applicant: ARTIKA FOR LIVING INC., Montreal (CA)

(72) Inventor: Mathieu Seguin, Montreal (CA)

(21) Appl. No.: 18/987,401

(22) Filed: Dec. 19, 2024

Related U.S. Application Data
(60) Provisional application No. 63/610,709, filed on Dec. 15, 2023.

(51) Int. Cl. H05B 47/19; H05B 45/10; H05B 45/20; H05B 47/105; H05B 47/165; H05B 47/185

(52) U.S. Cl. CPC H05B 47/19; H05B 45/10; H05B 45/20; H05B 47/105; H05B 47/165; H05B 47/185

(57) ABSTRACT

The present invention addresses the shortcomings of existing LED control systems by introducing a smart LED control system that revolutionizes lighting management. Unlike conventional systems, this innovation combines the convenience of a remote control, the extensive reach of a smartphone-compatible application, and the simplicity of a wall switch, offering users a comprehensive solution for controlling LED lighting environments. Key aspects of this invention include a versatile smart LED control panel that seamlessly integrates with existing LED setups. The control system includes a user-friendly remote control for effortless adjustment of brightness, color temperature, and effects. A dedicated smartphone application provides remote access and advanced customization options, enabling users to create dynamic lighting scenes, schedule changes, and synchronize lights with music or media. The wall switch ensures basic, hands-on control accessible to users of all technical levels.

### CROSS-REFERENCE TO RELATED APPLICATIONS

There are no cross-related applications.

### FIELD OF THE INVENTION

The present invention generally relates to a smart LED control system, specifically designed to provide intuitive and customizable control over LED lighting systems for a wide range of applications, from residential and commercial spaces to entertainment and decorative lighting setups.

### BACKGROUND OF THE INVENTION

The prior art in the field of LED lighting control has primarily relied on conventional systems that offer limited control options and often necessitate cumbersome manual adjustments. These traditional approaches often fall short in meeting the evolving needs and expectations of users seeking more intuitive and versatile ways to manage their LED lighting environments.

In this context, the present invention aims to address these shortcomings by introducing a smart LED control system that redefines the way LED lighting is controlled. This innovative system combines the convenience of a remote control, the flexibility and long-distance operation of a smartphone-compatible application, and the simplicity of a wall switch. The background of the invention lies in the recognition of the growing demand for comprehensive and user-friendly solutions that empower individuals to have greater control over their lighting, whether it's for residential, commercial, or entertainment purposes.

### SUMMARY OF THE INVENTION

The shortcomings of the prior art are generally mitigated by the innovative features of the present invention. Unlike conventional LED control systems, which typically offer limited control options and require cumbersome manual adjustments, the present smart LED control system combines the convenience of a remote control, the flexibility and long-distance operation of a smartphone-compatible application, and the simplicity of a wall switch, providing users with a comprehensive and user-friendly solution for managing their LED lighting environments.

The main aspects of the invention include a multifunctional smart LED control system that integrates seamlessly with existing LED lighting setups. This control system comprises a remote control with a user-friendly interface, allowing users to adjust brightness, color temperature, and color effects effortlessly. Additionally, a dedicated smartphone application provides remote access and advanced customization options, enabling users to create dynamic lighting scenes, schedule lighting changes, and even sync the LEDs with music or other media. The wall switch offers basic control for convenience and ease of use, making it accessible to individuals of all technological backgrounds.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is an illustration of a remote control for controlling LED lighting according to the principles of the present invention.

FIG. 2 is an illustration of a smart phone application for controlling LED lighting according to the principles of the present invention showing an interface connection page.

FIG. 3 is an illustration of a smart phone application for controlling LED lighting according to the principles of the present invention showing the options of the interface connection page.

FIG. 4 is an illustration of a smart phone application for controlling LED lighting according to the principles of the present invention showing a color selection page.

FIG. 5 is an illustration of a smart phone application for controlling LED lighting according to the principles of the present invention showing a scene selection page.

FIG. 6 is an illustration of a smart phone application for controlling LED lighting according to the principles of the present invention showing a music selection page.

FIG. 7 is an illustration of a smart phone application for controlling LED lighting according to the principles of the present invention showing the music rhythm of the music selection page.

FIG. 8 is an illustration of a smart phone application for controlling LED lighting according to the principles of the present invention showing a schedule selection page.

FIG. 9 is an illustration of a smart phone application for controlling LED lighting according to the principles of the present invention showing a timer option of the schedule selection page.

FIG. 10 is an illustration of a smart phone application for controlling LED lighting according to the principles of the present invention showing a time selection option of the timer option page.

FIG. 11 is an illustration of a smart phone application for controlling LED lighting according to the principles of the present invention showing the execution cycle of the timer option page.

FIG. 12 is an illustration of a smart phone application for controlling LED lighting according to the principles of the present invention showing a countdown option of the schedule selection page.

FIG. 13 is an illustration of a smart phone application for controlling LED lighting according to the principles of the present invention showing a countdown timer on the schedule selection page.

FIG. 14 is an illustration of a light switch for controlling LED lighting according to the principles of the present invention.

### DETAILED DESCRIPTION OF THE INVENTION

A novel smart LED control system will be described hereinafter. Although the invention is described in terms of specific illustrative embodiments, it is to be understood that the embodiments described herein are by way of example only and that the scope of the invention is not intended to be limited thereby.

The smart LED control system (not shown) comprises a control panel (not shown), a remote control 100, a smart control application 200, and a wall switch 300. The remote control 100 is a tool that may communicate with the LED control panel (not shown) over a mid-length distance and may function by infrared telecommunication. The smart control application 200 may control the LED control panel by a WIFI or internet independently of the distance. The light switch 300 is a fixture that may turn the LED control system (not shown) on or off.

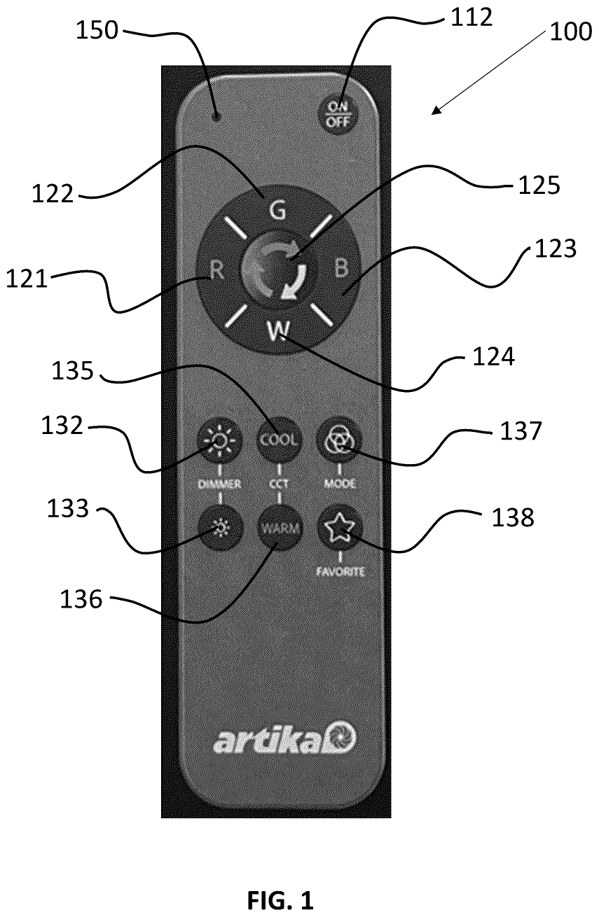

Referring to FIG. 1, the remote control 100 is a versatile device designed to interact with the LED control panel (not shown) efficiently. It operates over a mid-length distance and primarily utilizes infrared telecommunication technology to communicate with the LED control panel. This ergonomic and user-friendly device allows users to adjust various lighting parameters, such as brightness, color temperature, and lighting effects, from a convenient distance, making it ideal for scenarios where direct physical access to the control panel is limited. The remote control 100 comprises several buttons and an indicator light 150. The buttons may be divided into three classes: power button 112, hue buttons 12x family, and option buttons 13x family.

Still referring to FIG. 1, the power button 112 may allow the user to turn the LED control panel (not shown) on or off. The hue buttons 12x comprise five components, the red hue button 121, the green hue button 122, the blue hue button 123, the white hue button 124 and the variable hue button 125. The hue buttons 121-124 may allow the user to control the colours of the LED lights by adding red, green, blue, or white to the current colour of the LED lights. The variable hue button 125 allows the user to obtain lights of colours that automatically varies with time.

Still referring to FIG. 1, the option buttons 13x may be divided into three categories: dimmer buttons 131, temperature buttons 134, mode button 137, and favourite button 138. The dimmer buttons 131 allows the user to increase the LED lights intensity by using the increase intensity button 132 or decrease the LED lights intensity by using the decrease intensity button 133. The temperature buttons 134 allow the user to change the temperature of the light by using the cool temperature button 135 or the warm temperature button 136. The mode button 137 allows the user to select a pre-set or saved LED light setting. The favourite button 138 allows the user to save a current setting that may be accessed by the mode button 137. The indicator light 150 is a light that blinks whenever a button 110 is pressed so as to indicate to the user that the command was sent to the LED control panel (not shown).

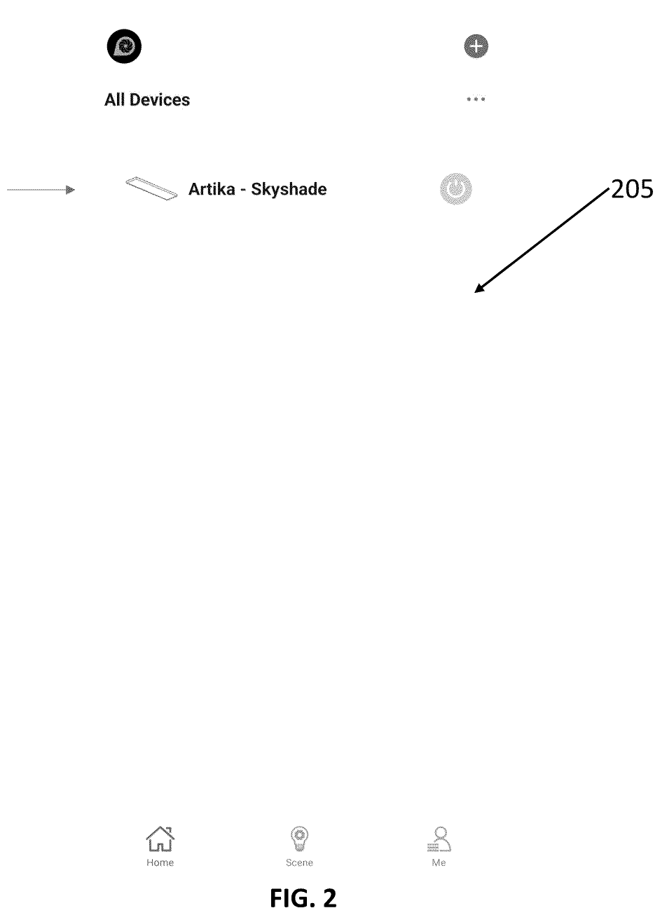

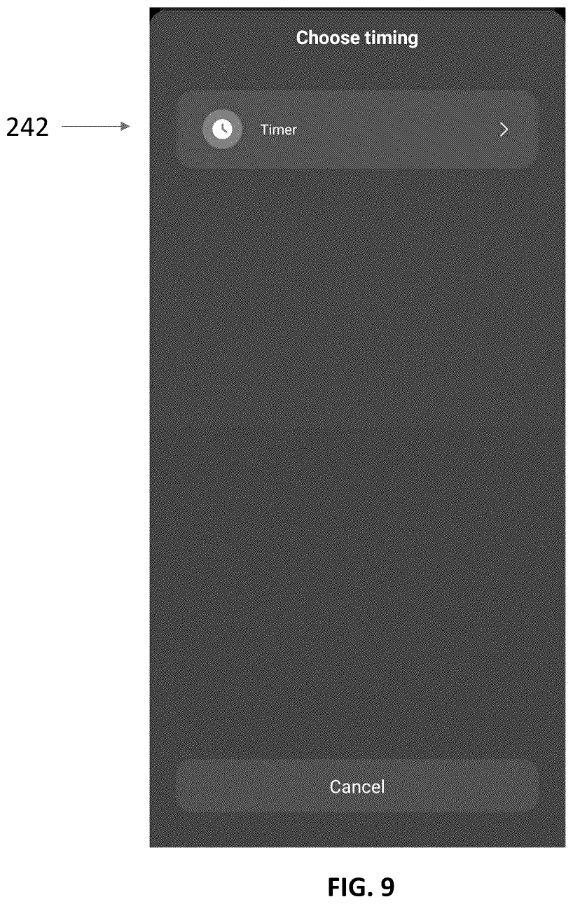

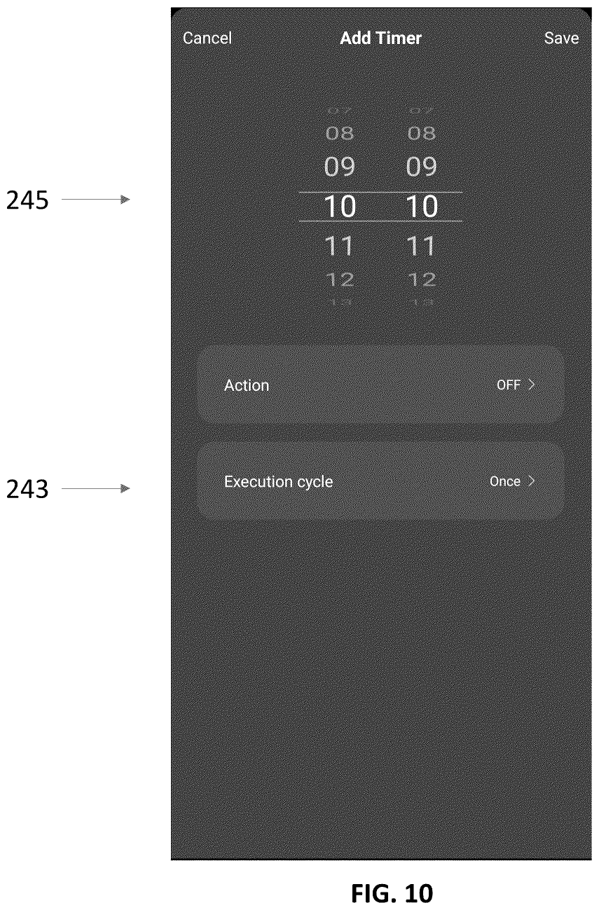

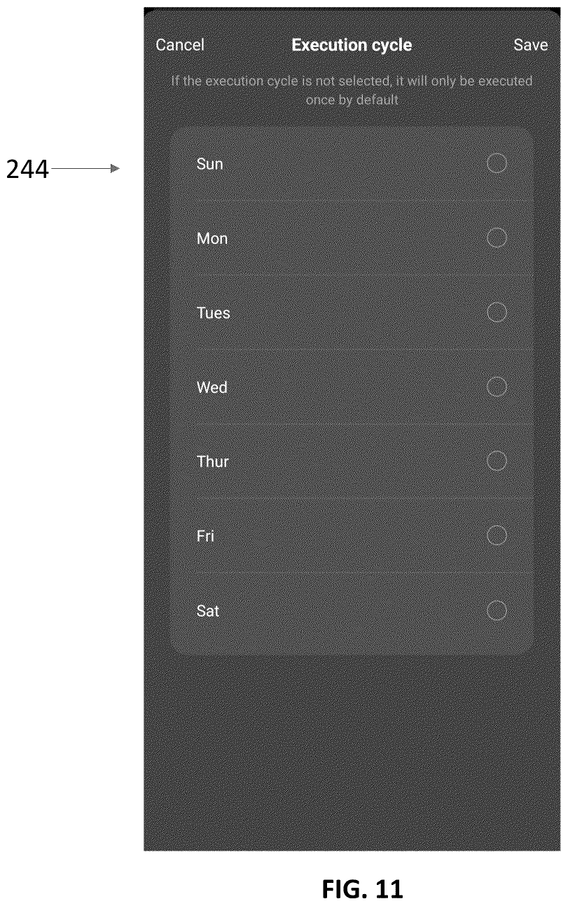

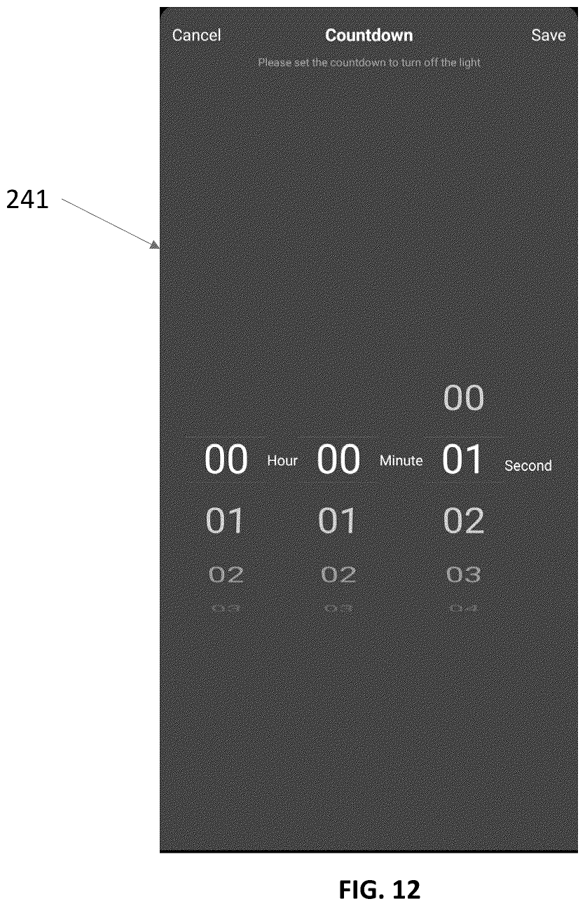

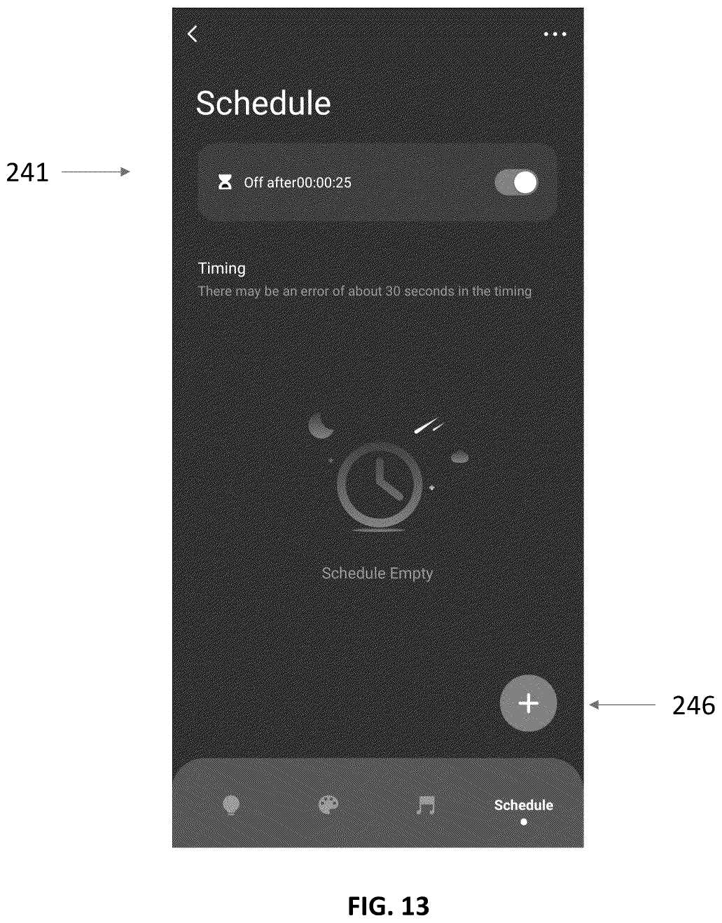

Referring now to FIGS. 2-13, the smart control application 200 represents a cutting-edge component of the LED control system (not shown). It offers users the capability to manage the LED lighting system independently of their physical location, thanks to its compatibility with WIFI or internet connectivity. This feature-rich control option provides users with a comprehensive set of tools accessible via a smartphone application or web interface. Users can remotely tailor their lighting experiences, create dynamic lighting scenes, schedule lighting changes, and even synchronize the LEDs with external factors, such as music or ambient conditions. The smart control application 200 comprises four pages 201 divided as follows: a home page 210, a colour palette page 220, a music page 230, and a schedule page 240.

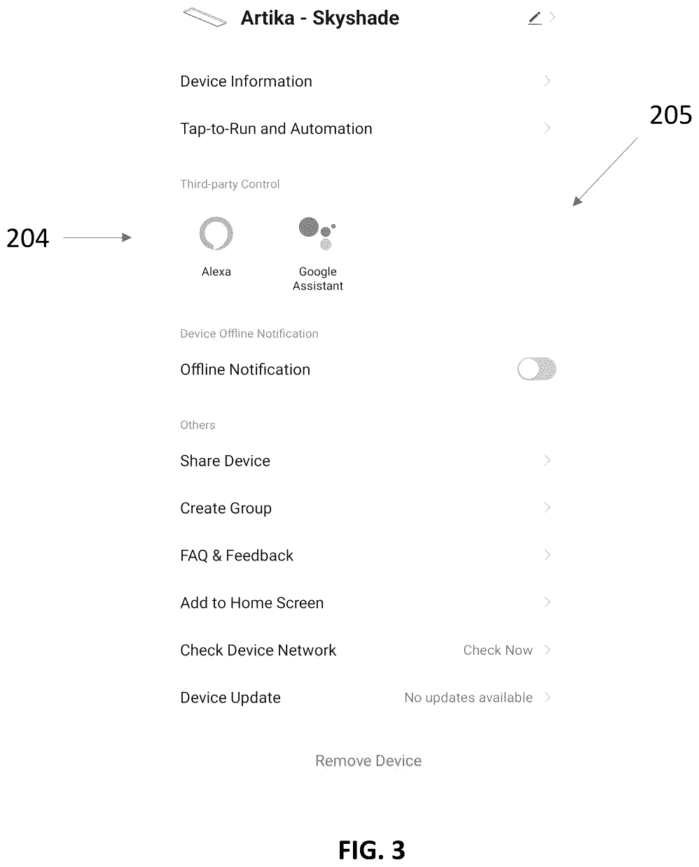

Referring now to FIGS. 2-3, the smart control application 200 comprises an interface connection page 205 and may be connected to a smart device and activated by a smart device. The connection page 205 may allow the user to choose how to use, control and automate the LED control system (not shown). For example, the LED control system (not shown) may be connected to a third-party control 204, such as, but not limited to, Alexa™ or Google Assistant™ in order to control the LED control system (not shown) vocally.

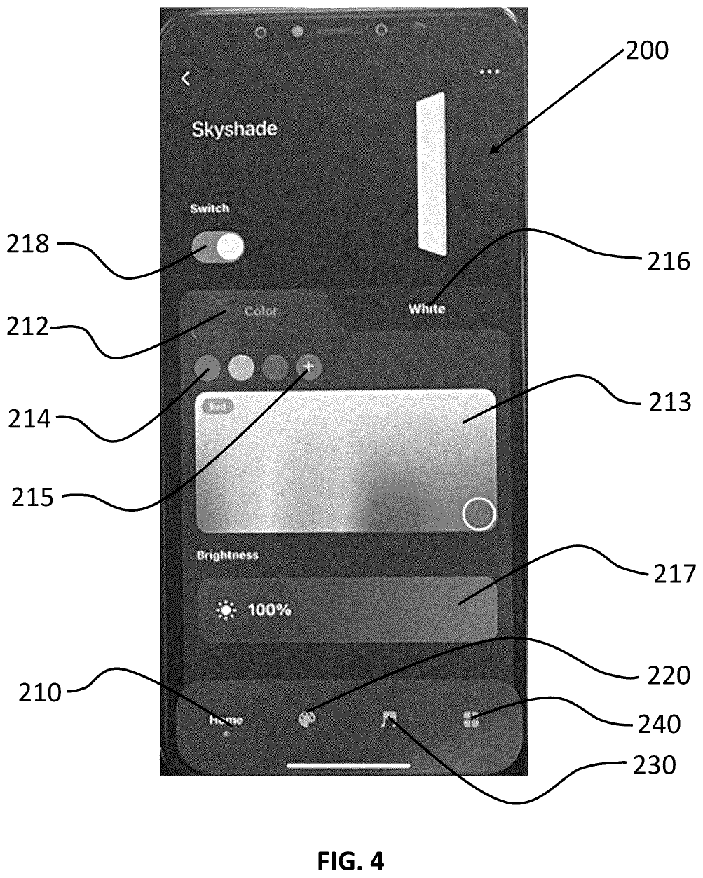

Referring now to FIG. 4, the home page 210 comprises two hue tabs 211, divided into a colour tab 212 and a white tab 216. The colour tab has a colour spectrum panel 213 in which the user may select a precise colour on the colour spectrum, preset colour buttons 214, and a colour addition button 215. The colour addition button 215 allows the user to save a particular colour selected on the colour spectrum panel 213. The white tab 216 allows the user to control the white balance of the LED lights in a similar way as the colour tab 212. The home page 210 may further comprise a brightness tab 217 in which the user can raise or lower the brightness of a particular colour component of the LED light. For example, by selecting a red preset colour button 214, the user may control the brightness of the red component of the LED lights. The home page may further comprise a switch button 218 that allows the user to turn the LED lights on or off.

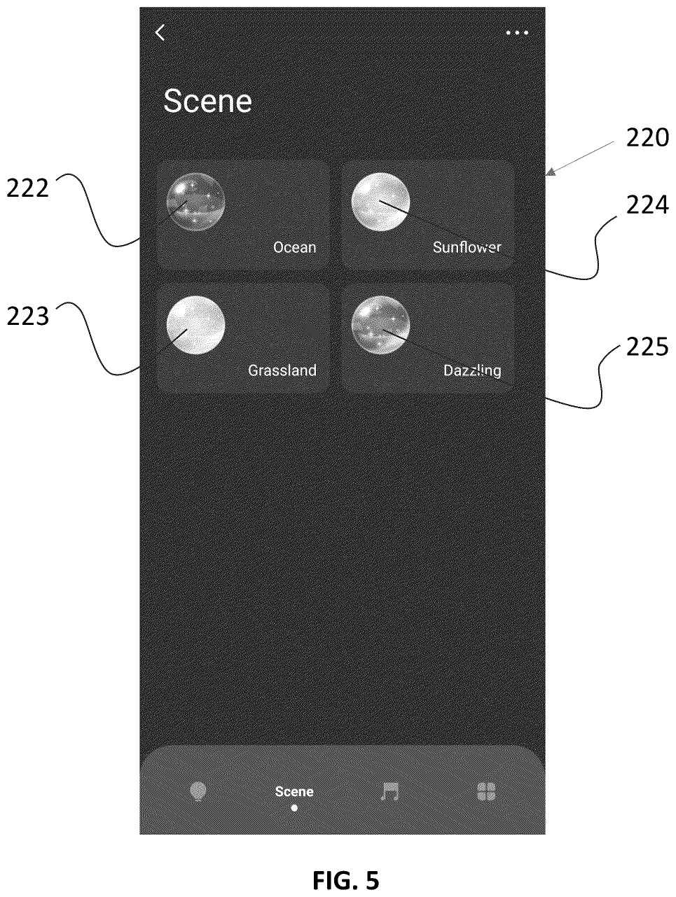

Referring now to FIG. 5, the smart control application 200 may further comprise a scene page 220. The scene page 220 allows the user to select a different pre-set atmosphere 221. The scene page 220 may comprise pre-set atmospheres 221 such as, but not limited to, an ocean atmosphere 222, a grassland atmosphere 223, a sunflower atmosphere 224, and a dazzling atmosphere 225. Understandably, these specific atmospheres are only a few examples of atmospheres. The user may also download more atmospheres 221 and add them to the library.

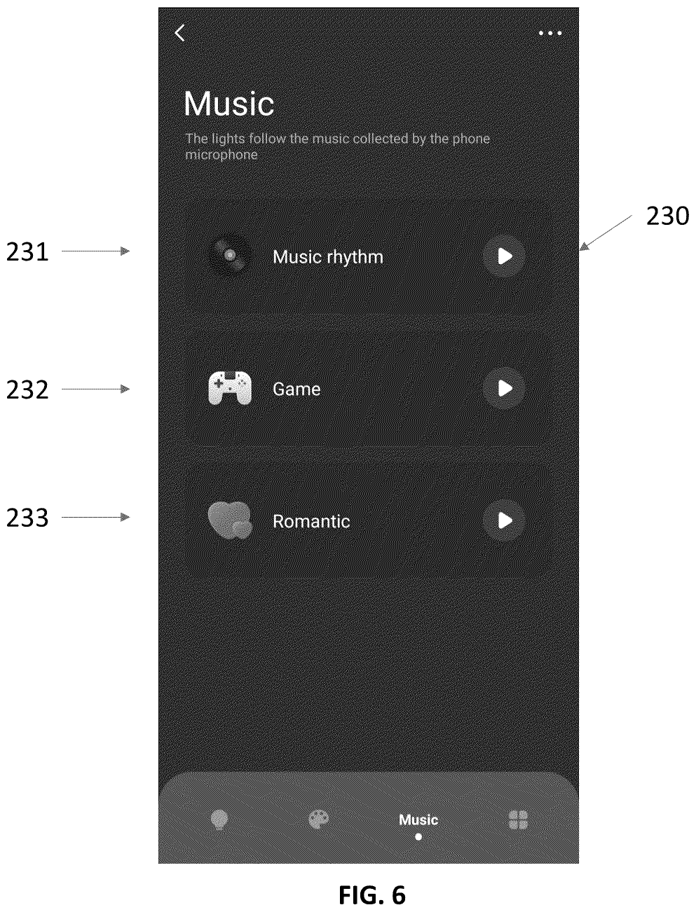

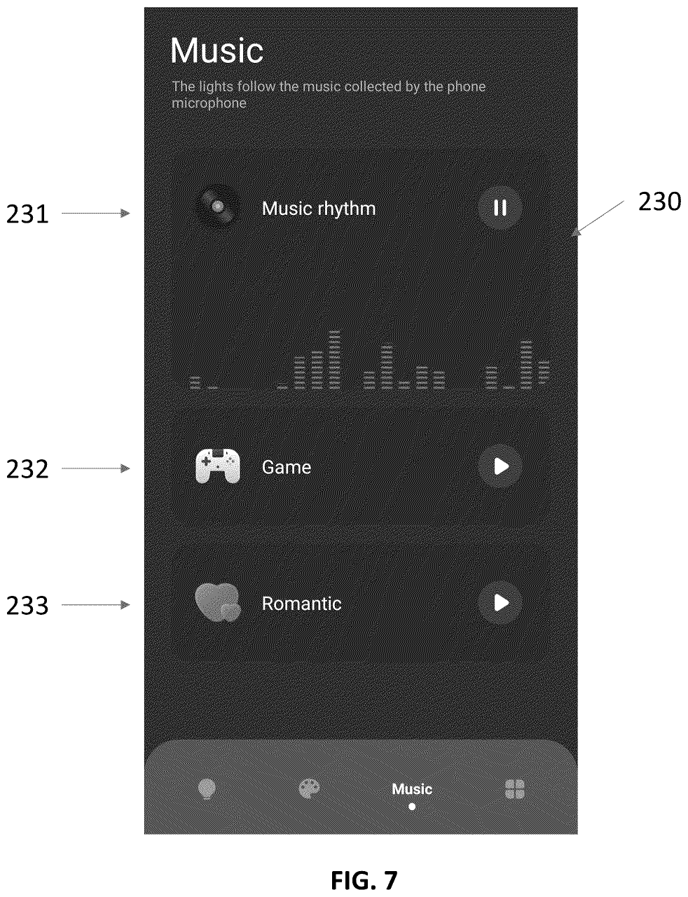

Referring now to FIGS. 6-7, the smart control application 200 may further comprise a music page 230. The music page 230 allows the user to connect the LED control system 10 to selected music and obtain a dynamic lighting scene that matches the ambient music. The music page 230 may comprise a music rhythm option 231, a game option 232, and a romantic option 233. Understandably, and other option of dynamic lighting according to an ambient sound may be added to the music page 230. The smart control application 200 may use the microphone of the smart device in order to collect the ambient sound data, and uses this data to adapt the lighting of the LED lights.

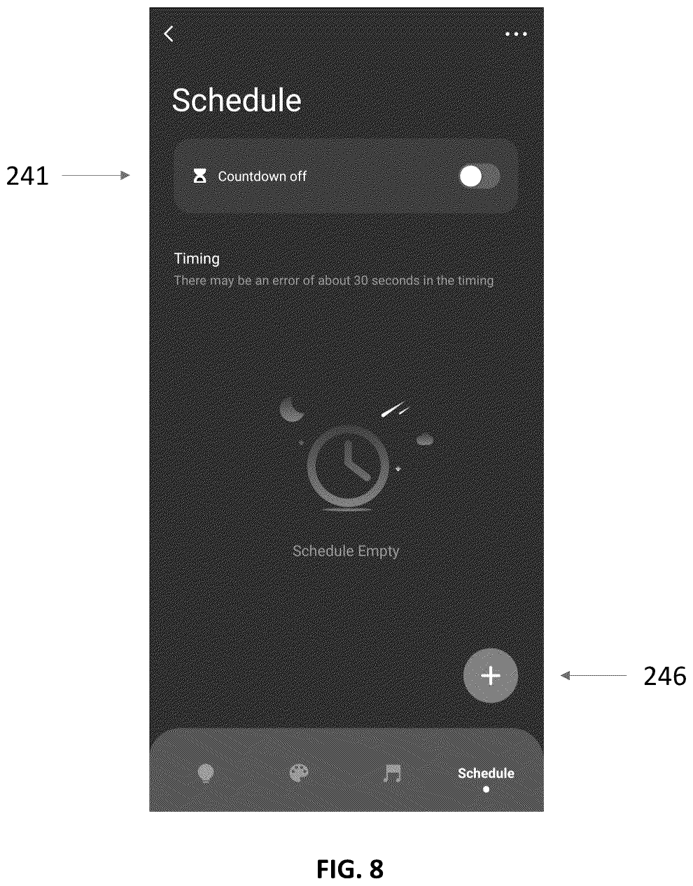

Referring now to FIGS. 8-13, the smart control application 200 may further comprise a schedule page 240. The schedule page 240 comprises everything that concerns the timing of the smart control application 200, such as, but not limited to, pre-set start and end of the lighting and countdowns. The schedule page 240 comprises a countdown option 241. The countdown option 241 allows the user to set the lighting to start after a certain amount of time. The schedule page 240 may further comprise a timer 242. The timer 242 allows the user to time the beginning, the ending and the duration of the lighting. On the schedule page 240, the timer 242 option may be added using a button 246. The schedule page may further comprise an execution cycle option 243, wherein the user may choose which days of the week 244 and which time of the day 245 would the LED control system (not shown) be automatically started.

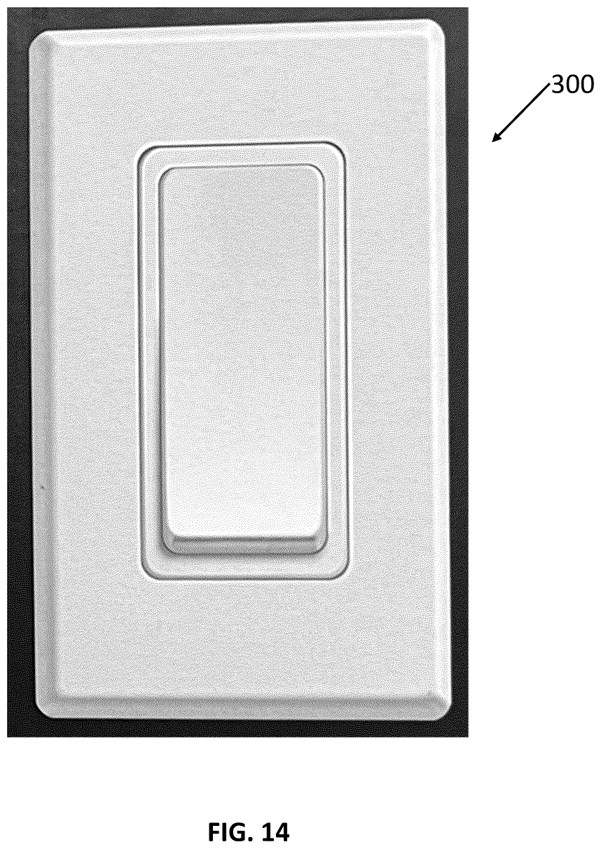

Referring now to FIG. 14, the wall switch 300 serves as a fundamental fixture within the LED control system (not shown). It functions as a simple yet effective means to turn the LED lights on or off with ease. The wall switch 300 may be mounted on a wall, ensures that users have immediate control over the lighting without the need for additional devices or digital interfaces. Its straightforward operation makes it accessible to users of all technical backgrounds and adds convenience to everyday lighting management tasks.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. An LED lighting control system, comprising:
a multifunctional LED control panel integrated with existing LED lighting setups;
a remote control with an interface for adjusting brightness, color temperature, and lighting effects, operable via infrared telecommunication;
a smartphone application compatible with WIFI or internet, configured to enable remote access, dynamic lighting customization, scheduling, and synchronization with external media; and
a wall switch controlling selected functionalities.

2. The system of claim 1, wherein the remote control comprises:
power buttons for turning the system on or off;
hue buttons for selecting or modifying light colors; and
optional buttons for controlling brightness, temperature, and lighting modes.

3. The system of claim 2, wherein the hue buttons include:
a red hue button,
a green hue button,
a blue hue button,
a white hue button, and
a variable hue button for generating automatically changing colors.

4. The system of claim 2, wherein the optional buttons include:
a dimmer button for increasing or decreasing brightness;
a temperature button for adjusting between cool and warm light settings;
a mode button for selecting predetermined lighting configurations; and
a favorite button for saving custom lighting settings.

5. The system of claim 1, wherein the smartphone application includes:
a home page for adjusting colors and brightness;
a scene page for selecting predetermined atmospheres;
a music page for synchronizing lighting with sound; and
a schedule page for setting timers and automation.

6. The system of claim 5, wherein the home page comprises:
a color spectrum panel for color selection;
pre-set color buttons for quick access;
a brightness control slider for individual color components; and
a switch button for turning the lights on or off.

7. The system of claim 5, wherein the scene page includes predetermined atmospheres and an option to download additional atmospheres.

8. The system of claim 5, wherein the music page is configured to:
synchronize lighting effects with the rhythm or tempo of ambient sound; or
adapt lighting dynamically using sound data captured by a microphone.

9. The system of claim 5, wherein the schedule page includes:
a countdown option for starting lighting effects after a specified delay;
a timer for defining the start, end, and duration of lighting sessions; and
an execution cycle option for repeating lighting sequences on specified days and times.

10. The system of claim 1, wherein the wall switch includes multi-click functionality to toggle between predetermined lighting modes.

11. The system of claim 1, wherein the remote control features an indicator light that blinks to confirm the transmission of commands to the LED control panel.

12. The system of claim 1, wherein the smartphone application supports integration with third-party control devices, including voice assistants.

13. The system of claim 1, wherein the control panel enables simultaneous management of multiple LED lighting setups.

14. The system of claim 1, wherein the smartphone application provides dynamic lighting effects based on external conditions, such as time of day or environmental brightness.

15. The system of claim 1, wherein the smartphone application enables users to share saved lighting configurations with other devices or users.

16. A method for controlling an LED lighting system, comprising:
integrating a multifunctional control panel with existing LED lighting setups;
adjusting brightness, color temperature, and lighting effects via a remote control operating through infrared telecommunication;
remotely customizing lighting settings, creating dynamic scenes, and scheduling lighting changes through a smartphone application connected via WIFI or internet; and
controlling selected functionalities using a wall switch.

17. The method of claim 16, further comprising enabling voice control of the lighting system by integrating the smartphone application with third-party devices such as Alexa™ or Google Assistant™.

18. The method of claim 16, further comprising creating dynamic lighting effects by synchronizing the LED lighting with ambient sound data captured through a device microphone.

19. The method of claim 16, wherein scheduling lighting changes includes:
setting a countdown timer for delayed lighting activation;
defining start and end times; and
repeating lighting effects on specified days of the week.

20. The method of claim 1, further comprising adjusting lighting settings using predetermined or user-defined configurations accessible via a remote control or smartphone application.
